(19) United States
(12) Patent Application Publication
(10) Pub. No.: US 2026/0171028 A1
(43) Pub. Date: Jun. 18, 2026

(54) PIXEL CIRCUIT, DISPLAY PANEL AND DISPLAY DEVICE

(71) Applicant: BOE TECHNOLOGY GROUP CO., LTD., Beijing (CN)

(72) Inventors: Tuo SUN, Beijing (CN); Li WANG, Beijing (CN); Baoyun WU, Beijing (CN); Yuanzhang ZHU, Beijing (CN); Xiyu ZHAO, Beijing (CN); Qiyang WU, Beijing (CN); Miao LIU, Beijing (CN)

(21) Appl. No.: 18/725,399

(22) PCT Filed: Aug. 16, 2023
(86) PCT No.: PCT/CN2023/113233

§ 371 Date: Jun. 28, 2024

(51) Int. Cl. G09G 3/3266; G09G 3/3233; G09G 3/36

(52) U.S. Cl. CPC G09G 3/3266; G09G 3/3233; G09G 3/3677; G09G 2300/0842; G09G 2300/0861; G09G 2310/0286; G09G 2310/08; G09G 2320/0233

(57) ABSTRACT

Disclosed are a pixel circuit, a display panel and a display device. The display device includes a timing control circuit, a gate driving circuit and a plurality of voltage signal lines; the timing control circuit is connected with the plurality of voltage signal lines, and is configured to determine an enable signal and a first signal when load information of the gate driving circuit changes, and adjust the voltage of at least one voltage signal line based on the enable signal and the first signal; the gate driving circuit includes a plurality of cascaded shift register units, which are respectively connected with the plurality of voltage signal lines and configured to output gate scan signals; the width of voltage adjustment is determined based on the pulse width of the first signal, and the starting position of voltage adjustment is determined based on the enable signal.

### TECHNICAL FIELD

Embodiments of the present disclosure relate to a pixel circuit, a display panel and a display device.

### BACKGROUND

In the field of display technology, for example, the pixel array of a liquid crystal display panel or an organic light-emitting diode (OLED) display panel usually includes a plurality of rows of gate lines and a plurality of columns of data lines interlaced with the gate lines. The driving of the gate lines can be realized by a bonded integrated driving circuit. In recent years, with the continuous improvement of the manufacturing process of amorphous silicon thin film transistors or oxide thin film transistors, the gate line driving circuit can also be directly integrated on the thin film transistor array substrate to form a GOA (Gate driver On Array), so as to drive the gate lines. For example, a GOA including a plurality of cascaded shift register units can be used to provide on-off state voltage signals (scan signals) to the plurality of rows of gate lines of the pixel array, so that, for example, the plurality of rows of gate lines are controlled to be turned on in sequence; and at the same time, data signals are provided to pixel units of corresponding rows in the pixel array by data lines, so that grayscale voltages required for displaying various grayscales of an image are formed in each pixel unit, thus displaying a frame of image.

Pixel circuits in OLED display panels generally adopt matrix driving mode, which can be divided into Active Matrix (AM) driving and Passive Matrix (PM) driving according to whether a switching element is introduced into each pixel unit. Although PMOLED has a simple process and low cost, it cannot meet the needs of high-resolution large-sized displays due to its drawbacks such as cross talk, high power consumption, and low lifespan. In contrast, AMOLED integrates a group of thin film transistors and a storage capacitor in the pixel circuit of each pixel; and by driving control of the thin film transistors and the storage capacitor, the current flowing through the OLED can be controlled, so that the OLED can emit light as needed. Compared with PMOLED, AMOLED needs less driving current, and has lower power consumption and longer service life, which can meet the requirements of large-size display with high resolution and multiple grayscales. At the same time, AMOLED has significant advantages in viewing angle, color reproduction, power consumption and response time, and is suitable for display devices with high information content and high resolution.

### SUMMARY

At least one embodiment of that present disclosure provide a display device, comprising a timing control circuit, a gate driving circuit and a plurality of voltage signal lines; the timing control circuit is connected with the plurality of voltage signal lines, and is configured to determine an enable signal and a first signal when load information of the gate driving circuit changes, and adjust a voltage of at least one voltage signal line among the plurality of voltage signal lines based on the enable signal and the first signal; the gate driving circuit comprises a plurality of cascaded shift register units, which are respectively connected with the plurality of voltage signal lines and configured to output gate scan signals; a width of a voltage adjustment is determined based on a pulse width of the first signal, and a starting position of the voltage adjustment is determined based on the enable signal.

For example, in the display device provided by at least one embodiment of the present disclosure, the plurality of voltage signal lines comprise a first voltage signal line and a second voltage signal line configured to provide a first voltage VGH and a second voltage VGL to the plurality of shift register units; a display stage and a blanking stage are comprised within a time period of one frame, and in the display stage, the voltage adjustment comprises adjusting the first voltage VGH to VGH+ΔV111 or adjusting the second voltage VGL to VGL−ΔV211 when the enable signal falls, wherein a width of ΔV111 and a width of ΔV211 are identical to the pulse width of the first signal.

For example, in the display device provided by at least one embodiment of the present disclosure, in the blanking stage, the voltage adjustment includes adjusting the first voltage VGH to VGH−ΔV12 or adjusting the second voltage VGL to VGL−ΔV22 in response to a rising edge of the enable signal, wherein a width of ΔV12 and a width of ΔV22 are identical to the pulse width of the first signal.

For example, in the display device provided by at least one embodiment of the present disclosure, the plurality of voltage signal lines comprise a first voltage signal line and a second voltage signal line configured to provide a first voltage VGH and a second voltage VGL to the plurality of shift register units; the voltage adjustment comprises adjusting the first voltage VGH to VGH−ΔV112 and adjusting the second voltage VGL to VGL−ΔV212 when the enable signal falls, wherein a width of ΔV212 is identical to the pulse width of the first signal, a width of ΔV112 is less than the pulse width of the first signal, and amplitudes of ΔV112 and ΔV212 are smaller than amplitudes of ΔV111 and ΔV211, respectively.

For example, in the display device provided by at least one embodiment of the present disclosure, the first voltage is greater than the second voltage.

For example, the display device provided by at least one embodiment of the present disclosure further comprises: pixel circuits arranged in an array, wherein the plurality of voltage signal lines comprise a first scan line and a first reset line; the first scan line is connected with a data writing circuit of the pixel circuit, so as to send a first scan signal received from the first scan line to a control terminal of the data writing circuit; the first reset line is connected with a control terminal of a first reset circuit of the pixel circuit, so as to provide a first reset signal, wherein the first reset circuit is turned on in response to the first reset signal; the plurality of voltage signal lines further comprise a first reset voltage line connected with the first reset circuit to provide a first reset voltage; the timing control circuit is further configured to determine a first phase difference based on the first scan signal and the first reset signal; the voltage adjustment further comprises adjusting the first reset voltage VINIT1 to VINIT1+ΔV31 at a position of the first phase difference from a falling edge of the enable signal when the enable signal falls, wherein a width of ΔV31 is identical to the pulse width of the first signal.

For example, the display device provided by at least one embodiment of the present disclosure further comprises: pixel circuits arranged in an array, wherein the plurality of voltage signal lines comprise a first scan line, the first scan line is connected with a data writing circuit of the pixel circuit, so as to send a first scan signal S3 to a control terminal of the data writing circuit, the voltage adjustment comprises adjusting a first level VGL_P of the gate driving circuit that outputs the first scan signal to VGL_P+ΔV51 when the enable signal falls, so as to adjust the first scan signal, wherein a width of ΔV51 is identical to the pulse width of the first signal.

For example, in the display device provided by at least one embodiment of the present disclosure, the plurality of voltage signal lines comprise a plurality of clock signal lines configured to provide a plurality of clock signals to the gate driving circuit that outputs the first scan signal; the voltage adjustment comprises adjusting a first level V0 of the plurality of clock signals to V0−ΔV61 when the enable signal falls, so as to adjust the first scan signal, wherein a count of clock signals for voltage adjustment is determined according to the pulse width of the first signal.

For example, in the display device provided by at least one embodiment of the present disclosure, the plurality of voltage signal lines further comprise a second scan line and a second reset line; the second scan line is connected with a threshold compensation circuit of the pixel circuit, so as to send a second scan signal to a control terminal of the threshold compensation circuit; the second reset line is connected with a second reset circuit of the pixel circuit to provide a second reset signal, wherein the second reset circuit is turned on in response to the second reset signal; the plurality of voltage signal lines further comprise a second reset voltage line connected with the second reset circuit to provide a second reset voltage; the timing control circuit is further configured to determine a second phase difference based on the second scan signal and the second reset signal; the voltage adjustment further comprises adjusting the second reset voltage VINIT2 to VINIT2+ΔV32 at a position of the second phase difference from the falling edge of the enable signal when the enable signal falls, wherein a width of ΔV32 is identical to the pulse width of the first signal.

For example, in the display device provided by at least one embodiment of the present disclosure, the plurality of voltage signal lines further comprise a data line connected with the data writing circuit of the pixel circuit and configured to provide a data signal Vdt to the data writing circuit; the timing control circuit is further configured to determine a third phase difference based on the first scan signal and a second scan signal; the voltage adjustment further comprises adjusting a first level of the data signal Vdt to Vdt+ΔV41 at a position of the third phase difference from the falling edge of the enable signal when the enable signal falls, wherein a width of ΔV41 is identical to the pulse width of the first signal.

For example, in the display device provided by at least one embodiment of the present disclosure, the plurality of voltage signal lines further comprise a trigger signal line configured to provide a trigger signal to the gate driving circuit; the first signal is a trigger signal.

At least one embodiment of the present disclosure also provides a pixel circuit, comprising: a driving circuit, a data writing circuit, a threshold compensation circuit, a storage circuit, a first light-emitting control circuit and a first reset circuit; the driving circuit comprises a control terminal, a first terminal and a second terminal, and is configured to control a driving current flowing through a light-emitting element; the data writing circuit is connected with the first terminal of the driving circuit, and is configured to write a data signal to the first terminal of the driving circuit in response to a first scan signal; the threshold compensation circuit is connected between the control terminal of the driving circuit and the second terminal of the driving circuit, and is configured to write a compensation signal based on the data signal to the control terminal of the driving circuit in response to a second scan signal; the storage circuit is connected with the control terminal of the driving circuit and a first voltage line, and is configured to store the compensation signal and hold the compensation signal at the control terminal of the driving circuit; the first light-emitting control circuit is connected with the first voltage line and the first terminal of the driving circuit, and is configured to apply a first voltage provided by the first voltage line to the first terminal of the driving circuit in response to a first light-emitting control signal; the first reset circuit is connected with the threshold compensation circuit, and is configured to apply a first reset voltage to the control terminal of the driving circuit in response to a first reset signal; the control terminal of the driving circuit and the storage circuit are connected at a first node, and the first light-emitting control circuit and the first terminal of the driving circuit are connected at a second node; a voltage of the first scan signal, the second scan signal, the data signal or the first reset voltage is configured to be adjusted based on an enable signal and a first signal determined when load information of a gate driving circuit changes, wherein a width of the voltage adjustment is determined based on a pulse width of the first signal, and a starting position of the voltage adjustment is determined based on the enable signal.

For example, in the pixel circuit provided by at least one embodiment of the present disclosure, the voltage adjustment comprises adjusting the first reset voltage VINIT1 to VINIT1+ΔV31 at a position of a first phase difference from a falling edge of the enable signal when the enable signal falls, wherein a width of ΔV31 is identical to the pulse width of the first signal.

For example, in the pixel circuit provided by at least one embodiment of the present disclosure, the first phase difference is determined based on the first scan signal and the first reset signal.

For example, in the pixel circuit provided by at least one embodiment of the present disclosure, the voltage adjustment comprises adjusting a first level VGL_P of the gate driving circuit that outputs the first scan signal to VGL_P+ΔV51 or adjusting a first level V0 of a plurality of clock signals of the gate driving circuit that outputs the first scan signal to V0−ΔV61 when the enable signal falls, so as to adjust the first scan signal, wherein a width of ΔV51 is identical to the pulse width of the first signal.

For example, in the pixel circuit provided by at least one embodiment of the present disclosure, the pixel circuit further comprises a second light-emitting control circuit and a second reset circuit; the second light-emitting control circuit is connected with the second terminal of the driving circuit and the light-emitting element, and is configured to apply a voltage of the second terminal of the driving circuit to the light-emitting element in response to a second light-emitting control signal; the second reset circuit is connected with the second light-emitting control circuit and the light-emitting element, and is configured to apply a second reset voltage to the light-emitting element in response to a second reset signal; the second light-emitting control circuit and the second terminal of the driving circuit are connected at a third node, and the second reset circuit, the second light-emitting control circuit and the light-emitting element are connected at a fourth node; the voltage adjustment further comprises adjusting the second reset voltage based on the enable signal and the first signal.

For example, in the pixel circuit provided by at least one embodiment of the present disclosure, the voltage adjustment comprises adjusting the second reset voltage VINIT2 to VINIT2+ΔV32 at a position of a second phase difference from the falling edge of the enable signal when the enable signal falls, wherein a width of ΔV32 is identical to the pulse width of the first signal.

For example, in the pixel circuit provided by at least one embodiment of the present disclosure, the second phase difference is determined based on the second scan signal and the second reset signal.

For example, in the pixel circuit provided by at least one embodiment of the present disclosure, the voltage adjustment further comprises adjusting a first level of the data signal Vdt to Vdt+ΔV41 at a position of a third phase difference from the falling edge of the enable signal when the enable signal falls, wherein a width of ΔV41 is identical to the pulse width of the first signal.

For example, in the pixel circuit provided by at least one embodiment of the present disclosure, the third phase difference is determined based on the first scan signal and the second scan signal.

At least one embodiment of the present disclosure also provides a display panel, comprising a plurality of pixel units, wherein each of the plurality of pixel units comprises the pixel circuit provided by any embodiment of the present disclosure.

### BRIEF DESCRIPTION OF DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a schematic diagram of a shift register unit provided by at least one embodiment of the present disclosure;

FIG. 2 is a schematic diagram of a display device provided by at least one embodiment of the present disclosure;

FIG. 3 is a flowchart of voltage adjustment provided by at least one embodiment of the present disclosure;

FIG. 4A is a schematic diagram of voltage adjustment of a second voltage in a display stage provided by at least one embodiment of the present disclosure;

FIG. 4B is a schematic diagram of voltage adjustment of a second voltage in a blanking stage provided by at least one embodiment of the present disclosure;

FIG. 5 is a schematic diagram of voltage adjustment of a first voltage provided by at least one embodiment of the present disclosure;

FIG. 6 is a schematic diagram of voltage adjustment of a clock signal provided by some embodiments of the present disclosure;

FIG. 7 is a schematic block diagram of a pixel circuit provided by at least one embodiment of the present disclosure;

FIG. 8 is a schematic diagram of a circuit structure of the pixel circuit shown in FIG. 7;

FIG. 9 is a timing chart for the pixel circuit shown in FIG. 8 provided by some embodiments of the present disclosure;

FIG. 10 is a schematic diagram of voltage adjustment of a first reset voltage VINIT1 provided by at least one embodiment of the present disclosure;

FIG. 11 is a schematic diagram of voltage adjustment of a second reset voltage VINIT2 provided by at least one embodiment of the present disclosure;

FIG. 12 is a schematic diagram of voltage adjustment of a data signal provided by at least one embodiment of the present disclosure;

FIG. 13 is a schematic diagram of voltage adjustment of a first scan signal S3 provided by at least one embodiment of the present disclosure;

FIG. 14 is a schematic diagram of combined adjustment of a first voltage and a second voltage provided by some embodiments of the present disclosure; and

FIG. 15 is a schematic block diagram of a display panel provided by some embodiments of the present disclosure.

### DETAILED DESCRIPTION

In order to make objects, technical solutions, and advantages of the embodiments of the present disclosure apparent, the technical solutions of the embodiments of the present disclosure will be described in a clearly and fully understandable way in connection with the drawings related to the embodiments of the present disclosure. Apparently, the described embodiments are just a part but not all of the embodiments of the present disclosure. Based on the described embodiments of the present disclosure, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and in the case where the position of the object which is described is changed, the relative position relationship may be changed accordingly.

With the gradual expansion of the application of AMOLED, the specifications are gradually improved, which leads to the gradual expansion of the display region (e.g., AA (Active Area)) of AMOLED and the gradual narrowing of the bezel. As a gate driving circuit that controls the pixel actions and affects the main nodes within the pixel, the layout area of its power source gradually decreases (the internal resistance gradually increases); at the same time, the increase of the width of AA and the increase of Pixels Per Inch (PPI) lead to the increase of the number of signals of the gate driving circuit, the increase of the number of nodes in the pixel, and the increase of the parasitic capacitance of signals from a single pixel to the gate driving circuit.

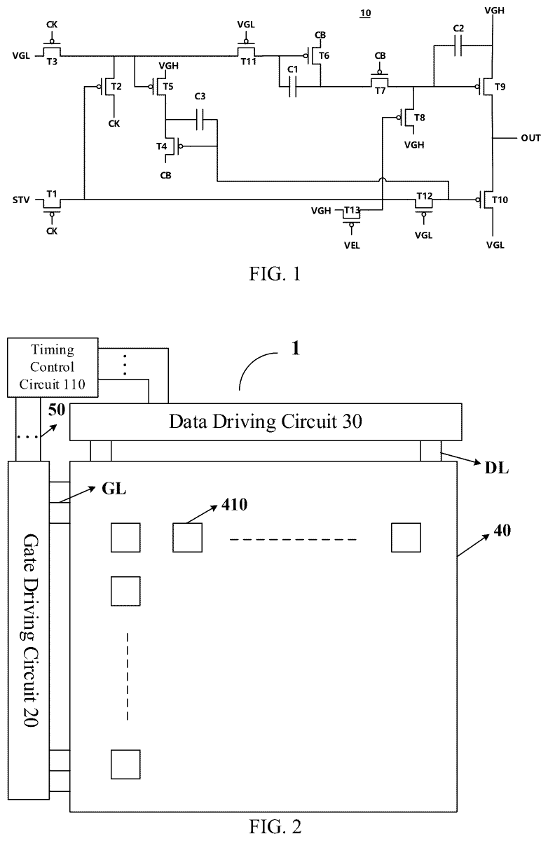

For a gate driving circuit that outputs waveforms through combined power voltages (VGH/VGL), such as the gate driving circuit composed of 13T3C shift register units shown in FIG. 1, there is a significant difference in the actual output current under the working conditions of output to the load and non-output to the load (such as manually pausing the output of the gate driving circuit or a blank area, etc.). Such difference lead to differences in power voltage, such as shift of reference voltage or shape difference of periodic waveform. These differences will directly affect the node jump of pixels and the on-off state transconductance of related transistors.

Due to the wide output waveform width of this type of gate driving circuit, when the load of a certain row of gate driving circuit begins to experience a sudden load change, the voltages of the waveforms of several rows of gate driving circuit before and after the certain row of gate driving circuit are affected, resulting in brightness difference in AA before and after the load-changed row, forming bright stripes or dark stripes, and affecting the display quality.

At least one embodiment of the present disclosure provides a display device, which includes a timing control circuit (IC), a gate driving circuit and a plurality of voltage signal lines. The timing control circuit is connected with the plurality of voltage signal lines, and is configured to determine an enable signal and a first signal when load information of the gate driving circuit changes, and adjust voltages of the plurality of voltage signal lines based on the enable signal and the first signal; the gate driving circuit includes a plurality of cascaded shift register units, which are respectively connected with the plurality of voltage signal lines and configured to output gate scan signals row by row; a width of the voltage adjustment is determined based on a pulse width of the first signal, and a starting position of the voltage adjustment is determined based on the enable signal.

In the display device provided by the above embodiment of the present disclosure, the waveform of the voltage signal input to the gate driving circuit is adjusted before and after the load change of the gate driving circuit, the voltage change is realized during the time period of the load change, and the influence of the sudden load change of the gate driving circuit on the output waveform is corrected, so that the output of the gate driving circuit is consistent with the output of other gate driving circuits during this time period, the uniformity of screen display is improved, the brightness difference is eliminated, the display effect is optimized, and the display quality is improved.

Hereinafter, the embodiments of the present disclosure will be described in detail with reference to the accompanying drawings. It should be noted that the same reference numerals in different drawings will be used to refer to the same elements that have been described.

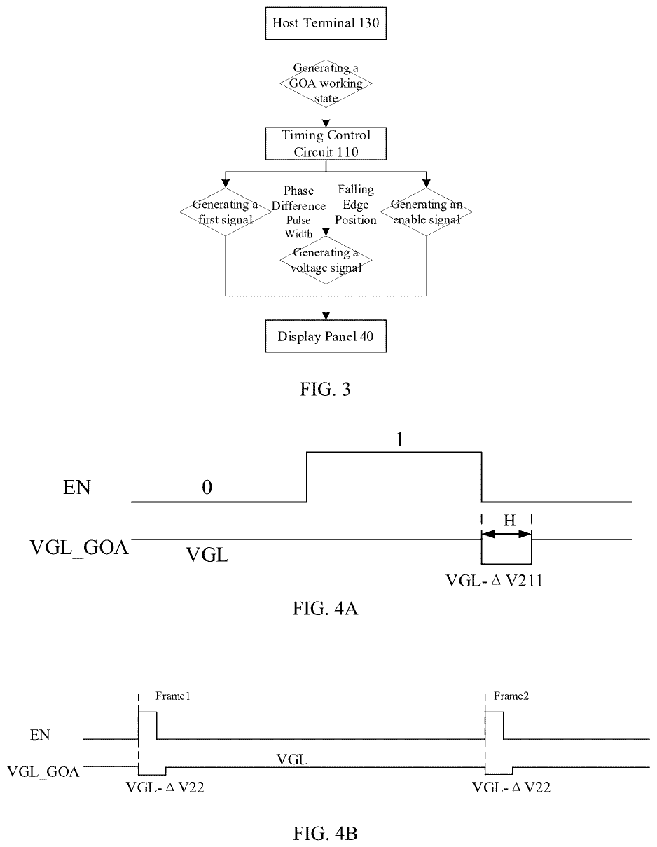

FIG. 1 is a schematic diagram of a shift register unit provided by at least one embodiment of the present disclosure; FIG. 2 is a schematic diagram of a display device provided by at least one embodiment of the present disclosure; FIG. 3 is a flowchart of voltage adjustment provided by at least one embodiment of the present disclosure; FIG. 4A is a schematic diagram of voltage adjustment of a second voltage in a display stage provided by at least one embodiment of the present disclosure; FIG. 4B is a schematic diagram of voltage adjustment of a second voltage in a blanking stage provided by at least one embodiment of the present disclosure; FIG. 5 is a schematic diagram of voltage adjustment of a first voltage provided by at least one embodiment of the present disclosure.

An embodiment of the present disclosure provides a display device 1. As shown in FIG. 2, the display device 1 includes a timing control circuit 110, a gate driving circuit 20, a plurality of voltage signal lines 50, and a plurality of pixel units 410 arranged in an array. For example, the display device 1 further includes a display panel 40, and a pixel array formed of the plurality of pixel units 410 is arranged on the display panel 40.

The gate scan signal output by each shift register unit 10 in the gate driving circuit 20 (as shown in FIG. 1, but not limited to the shift register unit shown in FIG. 1) is provided to the pixel unit 410. For example, the gate driving circuit 20 is electrically connected with the pixel unit 410 through a gate line GL (for example, as shown in FIG. 8, the gate line GL includes a first scan line S3 and a second scan line S4). The gate driving circuit 20 is used to provide a driving signal to the pixel array, and for example, the driving signal can drive a scan transistor and a reset transistor in the pixel unit 410.

For example, the display device 1 can further include a data driving circuit 30, and the data driving circuit 30 is used to provide data signals to the pixel array. For example, the data driving circuit 30 is electrically connected with the pixel units 410 through data lines DL.

It should be noted that the display device 1 in the present embodiment can be any product or component having display function, such as a LCD panel, a LCD TV, a display, an OLED panel, an OLED TV, an electronic paper display device, a mobile phone, a tablet computer, a laptop computer, a digital photo frame, a navigator, etc.

For example, the timing control circuit 110 is connected with the plurality of voltage signal lines 50, and is configured to determine an enable signal EN and a first signal when load information of the gate driving circuit 20 changes, and adjust the voltages of the plurality of voltage signal lines 50 based on the enable signal and the first signal.

For example, with reference to FIGS. 1 and 2, the plurality of voltage signal lines 50 further includes a trigger signal line STV configured to provide a trigger signal to the shift register units. The first signal can be a trigger signal, and can also be an output signal of the shift register unit. The first signal is used to determine that the pulse width of the voltage adjustment is identical to the pulse width of the output signal. Therefore, as long as the pulse width of the voltage signal can be made identical to the pulse width of the output signal, the embodiment of the present disclosure is not limited to this case. The following description takes that the first signal is a trigger signal as an example.

For example, the gate driving circuit 20 includes a plurality of cascaded shift register units 10, which are respectively connected with the plurality of voltage signal lines 50 and configured to output gate scan signals row by row.

For example, the shift register unit can be the shift register unit 10 shown in FIG. 1 or other shift register unit in this field, which is not limited in the embodiment of the present disclosure. Hereinafter, the shift register unit 10 shown in FIG. 1 will be taken as an example for illustration. As shown in FIG. 1, the shift register unit 10 includes a first transistor T1, a second transistor T2, . . . , a thirteenth transistor T13, and a first capacitor C1, a second capacitor C2 and a third capacitor C3. For example, the shift register unit can output a first voltage VGH as a gate scan signal row by row at the output terminal. For example, the output terminal of the shift register unit shown in FIG. 1 is connected with the second scan signal line S5 shown in FIG. 8 to control the conduction of the transistor M2, that is, the gate scan signal output in FIG. 1 can serve as the second scan signal in FIG. 8.

For example, the plurality of voltage signal lines 50 includes a first voltage signal line VGH and a second voltage signal line VGL, which are respectively connected with the first voltage terminal VGH and the second voltage terminal VGL of the shift register unit 10 to provide the first voltage VGH and the second voltage VGL.

For example, the width of voltage adjustment is determined based on the pulse width H of the first signal STV, and the starting position of voltage adjustment is determined based on the enable signal EN. For example, in the embodiment of the present disclosure, the pulse width H of the first signal is the pulse width of the output waveform of the GOA, and the following embodiments are identical to this case.

For example, as shown in FIG. 3, the host terminal obtains the working state of the gate driving circuit 20, and the working state includes, for example, manually pausing the output of the gate driving circuit 20 or a blank area, etc., such as an area where the gate driving circuit 20 does not output a waveform, which will lead to a sudden decrease of the load. Therefore, the load information can be obtained. For example, the load information includes the decrease or increase of the load. For example, the load information of the GOA includes that the output waveform is different from the output DC load by an A/A load, and the A/A load is the parasitic capacitance and resistance corresponding to the output of the GOA in the pixel. Generally, when the load of the gate driving circuit 20 suddenly decreases, the second voltage VGL generally decreases (changes negatively), and the first voltage VGH increases (changes positively) at the same time. In some examples, output anomalies due to load changes are adjusted by adjusting the signal voltage input to the shift register unit.

Taking the timing setting of local refresh as an example, the enable signal EN controls the output waveform of the shift register unit through the logic level. Taking that the shift register unit outputs a logic high level (e.g., the first voltage VGH or other voltage) as the waveform output (outputting an AC signal to drive the pixel to refresh) as an example, at the falling edge of the EN signal (that is, the load information of the gate driving circuit 20 changes (for example, the gate driving circuit 20 does not output, resulting in a sudden load decrease)), the waveform of the second voltage VGL input to the gate driving circuit 20 is adjusted to have a waveform with the lowest voltage of VGL-ΔV at this position, or the waveform of the first voltage VGH input to the gate driving circuit 20 is adjusted to have a pull-up waveform with the highest voltage of VGH+ΔV at this position, and ΔV can be adjusted to fit different panels. For example, the waveform can be a square wave or a triangular wave or a wave of other forms. The waveform width is based on the width of the output waveform of the gate driving circuit 20, and the actual setting width can be fine-tuned due to the delay in actual transmission. The timing is shown in FIG. 4A or 4B.

As shown in FIG. 3, in the actual module driving process, the host terminal 130 sends the information of waveform output on-off row numbers, and the enable signal EN and the first signal STV are generated in the timing control circuit 110; at the same time, the waveform of the voltage to be adjusted (e.g., the first voltage VGL, the second voltage VGH, the first scan signal S3, the second scan signal S5, the data signal Vdt, the first reset voltage VINIT1 or the second reset voltage VINIT2) is generated into a corresponding waveform according to a preset phase structure to compensate for the GOA power voltage caused by the load, and the compensated adjusted voltage is input to the gate driving circuit or the pixel circuit in the display panel, thereby eliminating the brightness difference and improving the uniformity of screen display.

For example, as shown in FIG. 5, in the display stage, the voltage adjustment includes adjusting the first voltage VGH to VGH+ΔV111 when the enable signal EN falls; or as shown in FIG. 4A, the second voltage VGL is adjusted to VGL−ΔV211. For example, the width of ΔV111 and the width of ΔV211 are identical to the pulse width of the first signal STV. For example, the first signal STV is a trigger signal input to the GOA. For example, ΔV111 can be about 50 mv-150 mv (millivolts), and ΔV211 can be about 0.8V-1.5V (volts), depending on the actual situation, for example, taking that the actual display effect (e.g., grayscale brightness) is uniform as a benchmark, which is not limited in the embodiment of the present disclosure.

For example, each frame includes a blanking stage and a display stage. In the display stage, the gate driving circuit outputs waveforms row by row, and in the blanking stage, the gate driving circuit 20 will not continue to output. When the gate driving circuit 20 has no waveform output, the power load will be reduced, and similar problems will occur. The compensation method is shown in FIG. 4B.

For example, as shown in FIG. 4B, only the first frame Frame1 and the second frame Frame2 are shown, and of course, more frames can be included, which is not limited in the embodiment of the present disclosure. For example, in the blanking stages of the first frame Frame1 and the second frame Frame2, the voltage adjustment includes adjusting the second voltage VGL to VGL−ΔV22 in response to the rising edge of the enable signal EN. For example, the width of ΔV12 and the width of ΔV22 are identical to the pulse width of the first signal STV. For example, the first signal STV is a trigger signal input to the GOA connected with the first voltage line VGH and the second voltage line VGL. For example, the rising edge of the enable signal EN is located at the starting position of each frame.

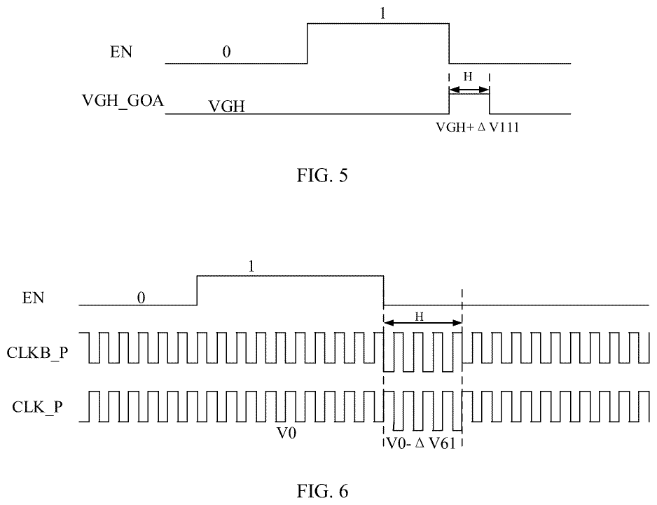

For example, in some other examples, the plurality of voltage signal lines includes a plurality of clock signal lines configured to provide a plurality of clock signals to the plurality of shift register units (to the plurality of shift register units in the gate driving circuit that outputs the first scan signal S3 shown in FIG. 8). For example, as shown in FIG. 6, the plurality of voltage signal lines includes a first clock signal line CLK connected with the first clock signal terminal CK shown in FIG. 1 to provide a first clock signal CLK, and a second clock signal line CLKB connected with the second clock signal terminal CB to provide a second clock signal CLKB. It should be noted that the number of clock signal lines is only an example, which is not limited in the embodiment of the present disclosure and can be determined depending on the actual situation. The first scan signal S3 will be described in FIG. 8 below and will not be described here.

For example, in the present example, by adjusting the voltage of the clock signal, the waveform of the clock signal of the GOA can be adjusted at the falling edge of the EN signal (that is, the time period when the GOA does not output and the power load suddenly decreases), so that the low-level voltage here can be adjusted by ΔV. This voltage change of ΔV can gradually realize the stable output of the GOA to adapt to the phenomenon adjustment. For example, the total number of CLK pulses is adjusted based on the width of the output waveform of the GOA. For example, in the embodiment of the present disclosure, the pulse width H of the output waveform of the GOA is identical to the width H of the first signal STV.

FIG. 6 is a schematic diagram of adjusting the voltage of the first scan signal S3 by adjusting the clock signal of the gate driving circuit that outputs the first scan signal S3. For example, as shown in FIG. 6, the voltage adjustment includes adjusting the first level V0 of the plurality of clock signals to V0−ΔV61 when the enable signal falls, so as to adjust the first scan signal S3. For example, the number of pulses of the clock signal for voltage adjustment is determined according to the pulse width of the first signal. For example, the first signal STV is a trigger signal input to the gate driving circuit that outputs the first scan signal S3 shown in FIG. 8.

For example, the first level V0 is a low level, and the voltage adjustment pulls down the low level of the clock signal when the enable signal falls, so as to ensure the normal output of the shift register unit.

In the display device provided by the above embodiment of the present disclosure, the waveform of the voltage signal input to the gate driving circuit is adjusted before and after the load change of the gate driving circuit, the voltage change is realized during the time period of the load change, and the influence of the sudden load change of the gate driving circuit on the output waveform is corrected, so that the output of the gate driving circuit is consistent with the output of other gate driving circuits during this time period, the uniformity of screen display is improved, the brightness difference is eliminated, the display effect is optimized, and the display quality is improved.

In some other embodiment, the signal voltage input to the pixel circuit can also be adjusted to ensure uniform display.

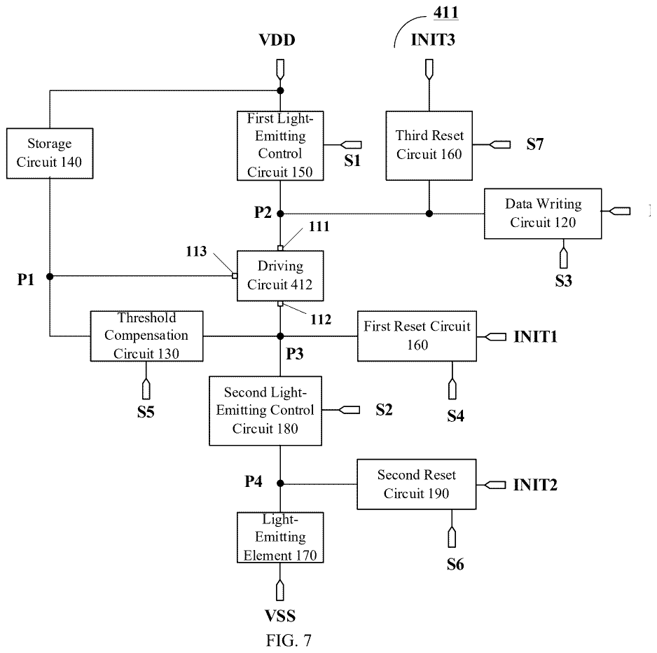

FIG. 7 is a schematic block diagram of a pixel circuit provided by at least one embodiment of the present disclosure.

As shown in FIG. 7, the pixel circuit 411 includes a driving circuit 412, a data writing circuit 120, a threshold compensation circuit 130, a storage circuit 140, a first light-emitting control circuit 150 and a first reset circuit 160.

For example, the driving circuit 412 includes a first terminal 111, a second terminal 112 and a control terminal 113, and is configured to control a driving current flowing through a light-emitting element 170. For example, in the light-emitting stage, the driving circuit 412 can provide a driving current to the light-emitting element 170 to drive the light-emitting element 170 to emit light, and light can be emitted according to the required “grayscale”. For example, the light-emitting element 170 can adopt any type of suitable element, and it can include various structures, which can be selected and set according to actual needs, without being limited in the embodiment of the present disclosure. For example, the light-emitting element 170 can be an OLED, a quantum dot light-emitting diode (QLED), a Micro light-emitting diode (Micro LED), etc., which may be determined according to actual needs.

The data writing circuit 120 is connected with the first terminal 111 of the driving circuit 412, and is configured to write a data signal to the first terminal 111 of the driving circuit 412 in response to a first scan signal. For example, the data writing circuit 120 is connected with a first scan line S3 and a data line DL, the first scan line S3 is used to provide a first scan signal, and the data line DL is used to provide a data signal. In the data writing stage, the data writing circuit 120 is turned on in response to the first scan signal provided by the first scan line S3, so as to write the data signal provided by the data line DL to the first terminal 111 of the driving circuit 412. The data signal is further written into the control terminal 113 of the driving circuit 412 through the driving circuit 412 and the threshold compensation circuit 130, and stored in the storage circuit 140, so as to generate a driving current for driving the light-emitting element 170 to emit light according to the data signal in the light-emitting stage.

The threshold compensation circuit 130 is connected between the control terminal 113 of the driving circuit 412 and the second terminal 112 of the driving circuit 412, and is configured to write a compensation signal based on the data signal to the control terminal 113 of the driving circuit 412 in response to a second scan signal. For example, the threshold compensation circuit 130 can be directly connected with the control terminal 113 and the second terminal 112 of the driving circuit 412, that is, directly connected between the control terminal 113 and the second terminal 112 of the driving circuit 412. Of course, the threshold compensation circuit 130 can also be indirectly connected between the control terminal 113 and the second terminal 112 of the driving circuit 412, that is, other circuits (e.g., the anti-leakage circuit 230 described later) can also be provided between the threshold compensation circuit 130 and the control terminal 113 of the driving circuit 412 and/or between the threshold compensation circuit 130 and the second terminal 112 of the driving circuit 412, which is not limited in the embodiment of the present disclosure.

For example, the threshold compensation circuit 130 is connected with a second scan line S5, and the second scan line S5 is used to provide a second scan signal. When the first scan signal provided by the first scan line S3 and the second scan signal provided by the second scan line S5 are both at effective levels, both the data writing circuit 120 and the threshold compensation circuit 130 are turned on, and at this time, the driving circuit 412 is also turned on; the data signal is transmitted to the threshold compensation circuit 130 through the data writing circuit 120 and the driving circuit 412, and the threshold compensation circuit 130 generates a compensation signal based on the data signal and writes the compensation signal to the control terminal 113 of the driving circuit 412. For example, in the data writing stage, the threshold compensation circuit 130 can electrically connect the control terminal 113 and the second terminal 112 of the driving circuit 412, so that the relevant information of the threshold voltage of the driving circuit 412 is also stored in the storage circuit 140 accordingly; thus, the stored voltage including the data signal and the threshold voltage can be used to control the driving circuit 412 in the light-emitting stage, so that the driving circuit 412 can be compensated.

The storage circuit 140 is connected with the control terminal 113 of the driving circuit 412 and a first voltage line VDD, and is configured to store the compensation signal and hold the compensation signal at the control terminal 113 of the driving circuit 412.

The first light-emitting control circuit 150 is connected with the first voltage line VDD and the first terminal 111 of the driving circuit 412, and is configured to apply a first voltage provided by the first voltage line VDD to the first terminal 111 of the driving circuit 412 in response to a first light-emitting control signal. For example, the first light-emitting control circuit 150 is connected with a first light-emitting control line S1, and the first light-emitting control line S1 is used to provide the first light-emitting control signal. The first light-emitting control circuit 150 can be turned on in response to the first light-emitting control signal, so that the first terminal 111 of the driving circuit 412 is electrically connected with the first voltage line VDD, thereby applying the first voltage provided by the first voltage line VDD to the first terminal 111 of the driving circuit 412.

The first reset circuit 160 is connected with the threshold compensation circuit 130, and is configured to apply a first reset voltage to the control terminal 113 of the driving circuit 412 in response to a first reset signal. For example, the first reset circuit 160 is connected with a first reset line S4 and a first reset voltage line INIT1, the first reset line S4 is used to provide the first reset signal, and the first reset voltage line INIT1 is used to provide the first reset voltage. The first reset circuit 160 can be turned on in response to the first reset signal, so as to transmit the first reset voltage to the second terminal 112 of the driving circuit 412; and the first reset voltage is further transmitted to the control terminal 113 of the driving circuit 412 through the threshold compensation circuit 130, so as to reset the control terminal 113 of the driving circuit 412.

The anode of the light-emitting element 170 receives the driving current provided by the driving circuit 412, the cathode of the light-emitting element 170 is connected with a second voltage line VSS, and the second voltage line VSS is used to provide a second voltage.

It should be noted that, for the purpose of description, the first voltage signal line VGH and the first voltage line VDD in various embodiments of the present disclosure, for example, keep inputting a DC high-level signal, which is called a first voltage; the second voltage signal line VGL and the second voltage line VSS, for example, keep inputting a DC low-level signal, which is called a second voltage (which can be a ground voltage) and is lower than the first voltage. The following embodiments are identical to this case, which will not be repeated.

For example, in some examples, the pixel circuit 411 further includes a second light-emitting control circuit 180 and a second reset circuit 190.

The second light-emitting control circuit 180 is connected with the second terminal 112 of the driving circuit 412 and the light-emitting element 170, and is configured to apply the voltage of the second terminal 112 of the driving circuit 412 to the light-emitting element 170 in response to a second light-emitting control signal. For example, the second light-emitting control circuit 180 is connected with a second light-emitting control line S2, and the second light-emitting control line S2 is used to provide the second light-emitting control signal. The second light-emitting control circuit 180 can be turned on in response to the second light-emitting control signal, so that the second terminal 112 of the driving circuit 412 is electrically connected with the light-emitting element 170 (e.g., with the anode of the light-emitting element 170), thereby applying the voltage of the second terminal 112 of the driving circuit 412 to the light-emitting element 170.

The second reset circuit 190 is connected with the second light-emitting control circuit 180 and the light-emitting element 170, and is configured to apply a second reset voltage to the light-emitting element 170 (e.g., to the anode of the light-emitting element 170) in response to a second reset signal. For example, the second reset circuit 190 is connected with a second reset line S6 and a second reset voltage line INIT2, the second reset line S6 is used to provide the second reset signal, and the second reset voltage line INIT2 is used to provide the second reset voltage. The second reset circuit 190 can be turned on in response to the second reset signal, so as to transmit the second reset voltage to the connection node between the second light-emitting control circuit 180 and the light-emitting element 170, so as to reset the light-emitting element 170.

For example, the control terminal 113 of the driving circuit 412 and the storage circuit 140 are connected at a first node P1, the first light-emitting control circuit 150 and the first terminal 111 of the driving circuit 412 are connected at a second node P2, the second light-emitting control circuit 180 and the second terminal 112 of the driving circuit 412 are connected at a third node P3, and the second reset circuit 190, the second light-emitting control circuit 180 and the light-emitting element 170 are connected at a fourth node P4. For example, the potential of the third node P3 after being reset by the first reset circuit 160 is greater than the potential of the fourth node P4 after being reset by the second reset circuit 190. Therefore, a better reset effect can be achieved, and the influence of residual charges on the potential of the anode of the light-emitting element in the light-emitting stage can be better reduced or eliminated.

For example, the pixel circuit shown in FIG. 7 further includes a third reset circuit 191, which is connected with the second node P2 and is configured to apply a third reset voltage to the second node P2 in response to a third reset signal. For example, the third reset circuit 191 is connected with a third reset line S7 and a third reset voltage line INIT3, the third reset line S7 is used to provide the third reset signal, and the third reset voltage line INIT3 is used to provide the third reset voltage. The third reset circuit 191 can be turned on in response to the third reset signal, so as to transmit the third reset voltage to the second node P2, thereby resetting the second node P2.

FIG. 8 is a schematic diagram of a circuit structure of the pixel circuit shown in FIG. 7. As shown in FIG. 8, the pixel circuit 411 includes transistors M1 to M7 and a storage capacitor Cst. For example, the transistor M3 is used as a driving transistor, and other transistors are used as switching transistors. The light-emitting element 170 can be implemented as a light-emitting element EL, and the light-emitting element EL can be, for example, an OLED. The embodiment of the present disclosure includes but is not limited to this case, and the following embodiments will be described by taking OLED as an example, which will not be repeated here. The OLED can be of various types, such as top emission, bottom emission, etc., and can emit red light, green light, blue light or white light, etc., which is not limited in the embodiment of the present disclosure.

For example, as shown in FIG. 8, in more detail, the driving circuit 412 can be implemented as a driving transistor, that is, the transistor M3. A gate electrode of the driving transistor (transistor M3) serves as the control terminal 113 of the driving circuit 412, a first electrode of the driving transistor (transistor M3) serves as the first terminal 111 of the driving circuit 412, and a second electrode of the driving transistor (transistor M3) serves as the second terminal 112 of the driving circuit 412.

The data writing circuit 120 can be implemented as a data writing transistor, that is, the transistor M4. A gate electrode of the data writing transistor (transistor M4) is connected with the first scan line (scan line S3) to receive the first scan signal, a first electrode of the data writing transistor (transistor M4) is connected with the data line (data line DL) to receive the data signal, and a second electrode of the data writing transistor (transistor M4) and the first electrode of the driving transistor (transistor M3) are connected at the second node P2.

The threshold compensation circuit 130 can be implemented as a threshold compensation transistor, that is, the transistor M2. A gate electrode of the threshold compensation transistor (transistor M2) is connected with the second scan line (scan line S5) to receive the second scan signal, a first electrode of the threshold compensation transistor (transistor M2) and a second electrode of the driving transistor (transistor M3) are connected at the third node P3, and the second electrode of the threshold compensation transistor (transistor M2) and the gate electrode of the driving transistor (transistor M3) are connected at the first node P1.

The storage circuit 140 can be realized as the storage capacitor Cst, a first electrode of the storage capacitor Cst is connected with the first voltage line VDD, and a second electrode of the storage capacitor Cst and the gate electrode of the driving transistor (transistor M3) are connected at the first node P1.

The first light-emitting control circuit 150 can be implemented as a first light-emitting control transistor, that is, the transistor M5. A gate electrode of the first light-emitting control transistor (transistor M5) is connected with the first light-emitting control line (scan line S1) to receive the first light-emitting control signal, a first electrode of the first light-emitting control transistor (transistor M5) is connected with the first voltage line VDD, and a second electrode of the first light-emitting control transistor (transistor M5) is connected with the first terminal of the driving circuit, that is, connected with the first electrode of the driving transistor (transistor M3) at the second node P2.

The first reset circuit 160 can be implemented as a first reset transistor, that is, the transistor M1. A gate electrode of the first reset transistor (transistor M1) is connected with the first reset line (scan line S4) to receive the first reset signal, a first electrode of the first reset transistor (transistor M1) is connected with the first reset voltage line (voltage line INIT1) to receive the first reset voltage, and a second electrode of the first reset transistor (transistor M1) and the second electrode of the driving transistor (transistor M3) are connected at the third node P3.

The second light-emitting control circuit 180 can be implemented as a second light-emitting control transistor, that is, the transistor M6. A gate electrode of the second light-emitting control transistor (transistor M6) is connected with the second light-emitting control line (scan line S2) to receive the second light-emitting control signal; a first electrode of the second light-emitting control transistor (transistor M6) is connected with the second terminal of the driving circuit, that is, connected with the second electrode of the driving transistor (transistor M3) at the third node P3; and a second electrode of the second light-emitting control transistor (transistor M6) and the anode of the light-emitting element EL are connected at the fourth node P4.

The second reset circuit 190 can be implemented as a second reset transistor, that is, the transistor M7. A gate electrode of the second reset transistor (transistor M7) is connected with the second reset line (scan line S6) to receive the second reset signal, a first electrode of the second reset transistor (transistor M7) is connected with the second reset voltage line (voltage line INIT2) to receive the second reset voltage, and a second electrode of the second reset transistor (transistor M7), the second electrode of the second light-emitting control transistor (transistor M6) and the light-emitting element EL are connected at the fourth node.

The third reset circuit 191 can be implemented as a third reset transistor, that is, the transistor M8. A first electrode of the third reset transistor (transistor M8) is connected with the third reset line INIT3, a second electrode of the third reset transistor (transistor M8) is connected with the second node P2, a gate electrode of the third reset transistor (transistor M8) is connected with the third reset line (scan line S7), and the third reset transistor (transistor M8) is turned on in response to the scan line S7, so as to connect the third reset line INIT3 with the second node P, thereby resetting the second node P2.

For example, the driving transistor (transistor M3), the data writing transistor (transistor M4), the first light-emitting control transistor (transistor M5) and the first reset transistor (transistor M1) are transistors of a first type; the threshold compensation transistor (transistor M2) is a transistor of a second type; and the first type is different from the second type. For example, in some examples, the transistor of the first type includes a P-type thin film transistor, and the transistor of the second type includes an N-type thin film transistor; that is, the driving transistor (transistor M3), the data writing transistor (transistor M4), the first light-emitting control transistor (transistor M5), the first reset transistor (transistor M1) are P-type thin film transistors, and the threshold compensation transistor (transistor M2) is an N-type transistor. Of course, the embodiment of the present disclosure is not limited to this case, and the types of some transistors used in the pixel circuit 411 can be changed according to actual needs; for example, a P-type thin film transistor can be changed into an N-type thin film transistor, or an N-type thin film transistor can be changed into a P-type thin film transistor.

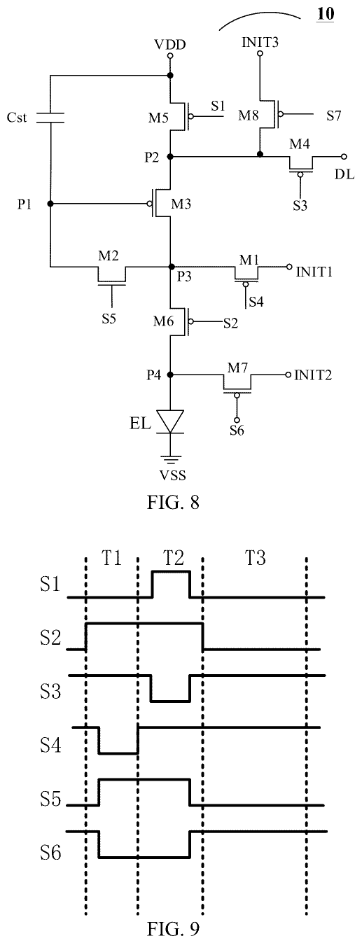

FIG. 9 is a timing chart for the pixel circuit shown in FIG. 8 provided by some embodiments of the present disclosure.

As shown in FIG. 9, in some examples, in the first stage T1, the gate electrode of the transistor M5 is connected with the scan line S1, S1 is at a low potential, the transistor M5 is turned on, and the high potential of the first voltage line VDD is written to the first electrode of the transistor M3, that is, to the second node P2; and the potential of the second node P2 is V1, which can be VDD or greater than 0 and less than VDD. The gate electrode of the transistor M1 is connected with the scan line S4, S4 is at a low potential, and the transistor M1 is turned on; the gate electrode of the transistor M2 is connected with the scan line S5, S5 is at a high potential, and the transistor M2 is turned on; and the low potential of the voltage line INIT1 is written to the second electrode (i.e. the third node P3) and the gate electrode (i.e. the first node P1) of the transistor M3. The gate electrode of the transistor M7 is connected with the scan line S6, S6 is at a low potential, and the transistor M7 is turned on; and the low potential of the voltage line INIT2 is written to the anode of the light-emitting element EL (i.e., the fourth node P4). Therefore, in the first stage T1, the anode of the light-emitting element EL, and the first electrode, the second electrode and the gate electrode of the transistor M3 are reset, and the residual charges of displaying a previous frame is eliminated, which is beneficial to the accurate data writing in the second stage T2.

In the second stage T2, S3 is at a low level, S5 is at a high level, the transistor M4 and the transistor M2 are turned on, and the data signal is written to the gate electrode of the transistor M3 through the transistor M4, the transistor M3 and the transistor M2 in turn; and at this time, the potential of the first node P1 is Vdt+|Vth|. Vdt is the data signal, and Vth is the threshold voltage of the transistor M3. In this stage, in order to ensure that the fourth node P4 can maintain a stable low potential before emitting light, in the second stage T2, the transistor M7 is still turned on, and the low potential of the voltage line INIT2 is written to the fourth node P4. That is, the fourth node P4 is reset in both the first stage T1 and the second stage T2.

In the third stage T3, the potentials of S1 and S2 are low potentials, the transistor M5 and the transistor M6 are turned on, and the light-emitting element EL emits light. The current flowing through the transistor M3 is: I=½ μ*W/L*Cox (Vgs−Vth)²=½ μ*W/L*Cox (VDD−Vdt)², where W/L is the width-to-length ratio of the transistor M3, Cox is the dielectric constant of the channel insulating layer of the transistor M3, and μ is the channel carrier mobility of the transistor M3. Through simulation, a good simulation effect was obtained, where the simulation conditions were: VDD was 4.6V, VSS was −3V, Vinit (i.e., INIT1 and INIT2) was −3V, Vdt was 3V, and Vth was −2V. Here, a good simulation effect means that the accuracy of writing data is high, and the potential of the anode of the light-emitting element in the light-emitting stage is almost unaffected by the residual charges.

As shown in FIG. 9, in the third stage T3, that is, in the light-emitting stage, the potential of the first voltage line VDD is VDD; in the non-light-emitting stage, including the first stage T1 for resetting and the second stage T2 for data writing, the potential of the first voltage line can be reduced to V1 in order to save power consumption. The potential of the second node P2 can be V1, that is, greater than 0 and less than or equal to VDD, so that the reset function can be realized.

In the present example, S2 and S5 can be signals output by the same gate driving circuit (e.g., GOA); S3 and S4 can be signals provided by the same kind of GOA, for example, S3 is a signal provided by a certain stage of shift register unit in the GOA, and S4 is a signal provided by a previous stage of shift register unit in the GOA. Therefore, for one row of pixel circuits, at least four GOAs are needed, or one stage of shift register unit of GOA needs to output four shift signals (if the GOA being adopted can output multiple signals, for example, one GOA can output two signals with different pulse widths or two signals with different potentials).

For example, in some examples, the first voltage VGH and/or the second voltage VGL in the GOAs that output the above S2-S6 can be adjusted to make the scan signals S2-S5 output to the pixel circuit normal, thus ensuring the display uniformity. The specific method of adjusting the first voltage and/or the second voltage can refer to the description in the above embodiments.

For example, in some other examples, by adjusting the driving voltage in pixels, taking LTPO (Low Temperature Polycrystalline Oxide) circuit as an example, its driving involves GOAs connected with S3, S4, S5, S6, S1 and S2, etc., and reference voltages such as VINIT1, VINIT2, VDD and VSS, etc., and data voltage Vdt.

For example, in some examples, by adjusting the waveform of the DC reference potential (e.g., increasing the waveform ΔV as shown below), the display uniformity near the GOA load switching position is improved. For example, in some examples, the first reset voltage VINIT1 can be adjusted; taking a bright stripe caused by S3 waveform at the switching position as an example, a pull-up waveform can be created at a specific position (for example, at the position of a first phase difference from the falling edge of the enable signal described below), and the phase relationship between the falling edge of the pull-up waveform and the falling edge of the enable signal EN is based on the phase difference between the waveform of the first scan signal S3 and the waveform of the first reset signal S4, and fine-tuning is performed depending on delay state and display effect.

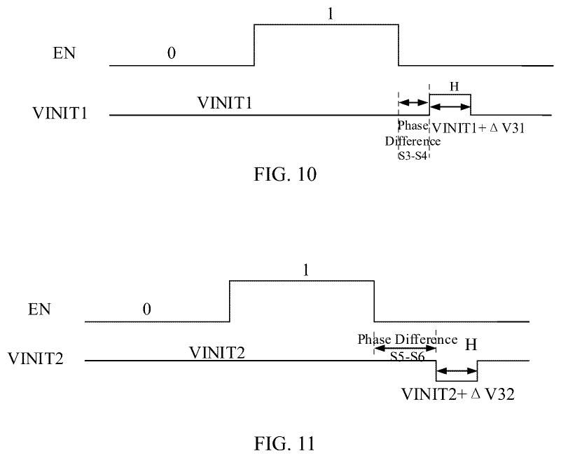

FIG. 10 is a schematic diagram of voltage adjustment of a first reset voltage VINIT1 provided by at least one embodiment of the present disclosure. For example, in the present example, the plurality of voltage signal lines can include a first scan line S3 and a first reset line S4. For example, as shown in FIGS. 7 and 8, the first scan line S3 is connected with the data writing circuit 120 of the pixel circuit, so as to send the first scan signal S3 to the control terminal of the data writing circuit 120; the first reset line S4 is connected with the control terminal of the first reset circuit 160 of the pixel circuit, so as to provide a first reset signal S4. For example, the first reset circuit 160 is turned on in response to the first reset signal S4; the plurality of voltage signal lines 50 further include a first reset voltage line INIT1 connected with the first reset circuit 160 to provide a first reset voltage VINIT1; the timing control circuit 110 is further configured to determine a first phase difference based on the first scan signal S3 and the first reset signal S4. For example, as shown in FIG. 10, the voltage adjustment further includes adjusting the first reset voltage VINIT1 to VINIT1+ΔV31 at a position with the first phase difference from the falling edge of the enable signal EN when the enable signal EN falls; for example, the width of ΔV31 is identical to the pulse width of the first signal STV, and for example, identical to the pulse width of S3. For example, the first signal STV is a trigger signal input to the gate driving circuit that outputs the first scan signal S3 shown in FIG. 8. For example, ΔV31 can be about 1V, depending on the actual situation, for example, taking that the actual display effect (e.g., grayscale brightness) is uniform as a benchmark, which is not limited in the embodiment of the present disclosure.

For example, in some other examples, taking a bright stripe caused by S5 waveform at the switching position as an example, a pull-down or pull-up waveform is created at a specific position, and the phase relationship between the falling edge of the pull-down or pull-up waveform and the falling edge of the enable signal EN is based on the phase difference between S5 waveform and S6 waveform, and fine-tuning can be performed depending on delay state and display effect (e.g., grayscale brightness). The waveform timing is shown in FIG. 11.

FIG. 11 is a schematic diagram of voltage adjustment of a second reset voltage VINIT2 provided by at least one embodiment of the present disclosure. For example, in the present example, the plurality of voltage signal lines further include a second scan line S5 and a second reset line S6.

For example, the second scan line S5 is connected with the threshold compensation circuit 130 of the pixel circuit, so as to send the second scan signal S5 to the control terminal of the threshold compensation circuit 130; the second reset line S6 is connected with the second reset circuit 190 of the pixel circuit to provide a second reset signal, wherein the second reset circuit 190 is turned on in response to the second reset signal; the plurality of voltage signal lines further include a second reset voltage line VINIT2 connected with the second reset circuit 190 to provide a second reset voltage VINIT2.

For example, the timing control circuit is further configured to determine a second phase difference based on the second scan signal S5 and the second reset signal S6. For example, as shown in FIG. 11, the voltage adjustment further includes adjusting the second reset voltage VINIT2 to VINIT2+ΔV32 at the position of the second phase difference from the falling edge of the enable signal EN when the enable signal EN falls, wherein the width of ΔV32 is identical to the pulse width of the first signal, for example, identical to the pulse width of S5. For example, the first signal STV is a trigger signal input to the gate driving circuit that outputs the second scan signal S5 shown in FIG. 8. For example, ΔV32 can be about 1V, positive or negative, depending on the actual situation, for example, taking that the actual display effect (e.g., grayscale brightness) is uniform as a benchmark, which is not limited in the embodiment of the present disclosure.

For example, in some other examples, the display uniformity near the GOA load switching position can be improved by additionally compensating a voltage in the data signal Vdt.

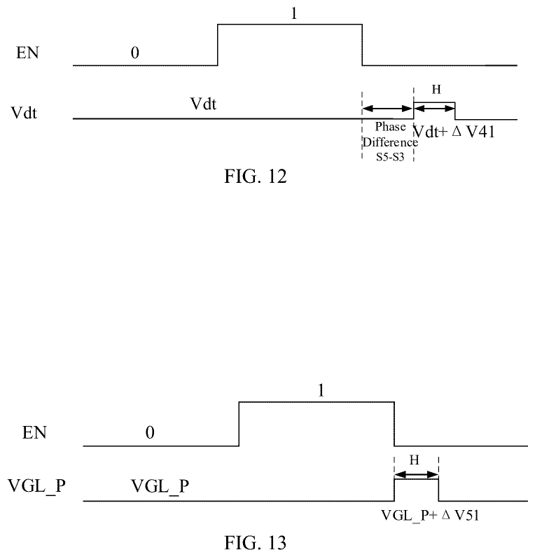

For example, taking a bright stripe caused by S5 waveform at the switching position as an example, a pull-up waveform is created at a specific position, the waveform shape can be a square wave or a triangular wave, etc., and can be adjusted; the phase relationship between the falling edge of the pull-up waveform and the falling edge of EN falling edge is based on the phase difference between S5 waveform and S3 waveform, and fine-tuning can be performed depending on delay state and display effect, which is not limited in the embodiment of the present disclosure. The timing sequence is shown in FIG. 12.

For example, in the present example, the plurality of voltage signal lines further include a data line DL connected with the data writing circuit 120 of the pixel circuit and configured to provide a data signal Vdt to the data writing circuit 120. For example, the timing control circuit is further configured to determine a third phase difference S5-S3 based on the first scan signal S3 and the second scan signal S5. As shown in FIG. 12, the voltage adjustment further includes adjusting the first level of the data signal Vdt to Vdt+ΔV41 at the position of the third phase difference S5-S3 from the falling edge of the enable signal EN when the enable signal EN falls. For example, the width of ΔV41 is identical to the pulse width of the first signal, for example, identical to the pulse width of S5. For example, the first signal STV is a trigger signal input to the gate driving circuit that outputs the second scan signal S5 shown in FIG. 8. For example, ΔV41 can be about 30 mv-50 mv (millivolts), depending on the actual situation, for example, taking that the actual display effect (e.g., grayscale brightness) is uniform as a benchmark, which is not limited in the embodiment of the present disclosure.

For example, in some other examples, uniform display of the display panel can also be achieved by adjusting the output of the first scan signal S3. For example, when the pixel is affected to become brighter (or darker), the charging rate of the pixel can be increased (or decreased), so as to compensate for the strip-shaped brightness difference resulting from the waveform difference generated by the change of output of other GOAs with load change. For example, adjusting the waveform of the first scan signal S3 can be achieved by adjusting the first level of the gate driving circuit 20 that outputs the first scan signal S3 or adjusting the voltage setting of the clock signals of the gate driving circuit 20 that outputs the first scan signal S3.

For example, the voltage adjustment of the clock signals of the gate driving circuit 20 that outputs the first scan signal S3 is shown in FIG. 6 as described above, and details will not be repeated here; and adjusting the first level VGL_P of the gate driving circuit can refer to the following description of the embodiment shown in FIG. 13.

For example, the first scan signal is adjusted by adjusting the voltage (e.g., low voltage) of the first level VGL_P of the gate driving circuit that outputs the first scan signal S3 from VGL_P to VGL_P+ΔV, and ΔV can be positive or negative.

For example, at the falling edge of the EN signal (for example, the GOA does not output, resulting in a sudden load decrease), the waveform of the first level of the gate driving circuit 20 that outputs the first scan signal S3 is adjusted, so as to have a waveform with the lowest voltage, for example, VGL_P+ΔV, at this position; and the waveform can be a square wave or a triangular wave or a wave of other forms. The waveform width is based on the width of the output waveform (e.g., the first scan signal S3) of the GOA, and the actual setting width can be fine-tuned due to the delay in actual transmission, which is not limited in the embodiment of the present disclosure. The timing sequence is shown in FIG. 13.

FIG. 13 is a schematic diagram of adjusting the voltage of the first scan signal S3 by adjusting the waveform of the first level of the gate driving circuit 20 that outputs the first scan signal S3 according to at least one embodiment of the present disclosure. As shown in FIG. 13, the voltage adjustment includes adjusting the first level VGL_P (e.g., low level) of the first scan signal S3 to VGL_P+ΔV51 when the enable signal EN falls. For example, the width of ΔV51 is identical to the pulse width of the first signal, for example, identical to the pulse width of S3. For example, the first signal STV is a trigger signal input to the gate driving circuit that outputs the first scan signal S3 shown in FIG. 8. For example, ΔV51 can be about 0.8V-1.5V, positive or negative, depending on the actual situation, for example, taking that the actual display effect (e.g., grayscale brightness) is uniform as a benchmark, which is not limited in the embodiment of the present disclosure.

For example, the first level can be provided by the first voltage line VGL or by other voltage line, which is not limited in the embodiment of the present disclosure.

The voltage adjustments involved in various embodiments of the present disclosure is different, which can correspond to fine adjustment (high precision) and coarse adjustment (power saving). Therefore, the adjustments involved in various embodiments of the present disclosure can be arbitrarily combined, so as to ensure achieving precise control of compensation amplitude (row by row or region by region) on the premise of that each compensation signal is not finely adjusted (e.g., voltage progression, special waveform, etc.), thereby saving power consumption. The following description takes the combination of the first voltage VGH and the second voltage VGL as an example.

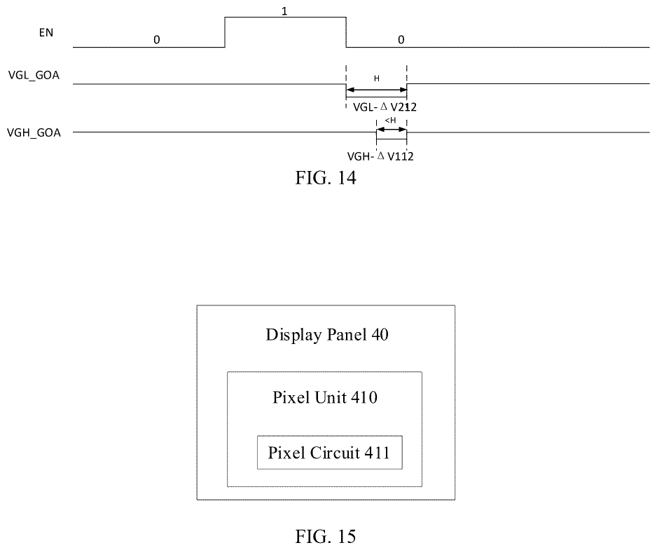

For example, in some other examples, as shown in FIG. 14, the voltage adjustment includes adjusting the first voltage VGH to VGH−ΔV112 and adjusting the second voltage VGL to VGL−ΔV212 when the enable signal EN falls, wherein the width of ΔV112 is identical to the pulse width H of the first signal, the width of ΔV212 is less than the pulse width H of the first signal, and the amplitudes of ΔV112 and ΔV212 are smaller than the amplitudes of ΔV111 and ΔV211, respectively, thus reducing power consumption while achieving compensation. For example, the first signal STV is a trigger signal input to the gate driving circuit connected with the first voltage line VGH and the second voltage line VGL.

It should be noted that it can also be combined with other signal voltages, such as a clock signal, a data signal, a scan signal or a reset voltage, etc., which is not limited in the embodiment of the present disclosure.

It should be noted that the variation AV of the voltage adjustment in the drawings is shown in the form of square wave, but the embodiment of the present disclosure is not limited thereto, and it can also be a triangular wave or a wave of other forms, as long as the stable output of GOA can be realized.

At least one embodiment of the present disclosure further provides a pixel circuit. As shown in FIG. 7, the pixel circuit 411 includes a driving circuit 412, a data writing circuit 120, a threshold compensation circuit 130, a storage circuit 140, a first light-emitting control circuit 150 and a first reset circuit 160. The specific structure and working process of the pixel circuit can refer to the description of FIGS. 7-9, and details will not be repeated here.

For example, in some examples, the voltage of the first scan signal S3, the second scan signal S5, the data signal Vdt or the first reset voltage VINIT1 is configured to be adjusted based on the enable signal EN and the first signal STV determined when the load information of the gate driving circuit 20 changes. For example, the width of the voltage adjustment is determined based on the pulse width of the first signal STV, and the starting position of the voltage adjustment is determined based on the enable signal EN.

For example, in some examples, as shown in FIG. 10, the voltage adjustment includes adjusting the first reset voltage VINIT1 to VINIT1+ΔV31 at a position of a first phase difference from the falling edge of the enable signal EN when the enable signal EN falls. For example, the width of ΔV31 is identical to the pulse width of the first signal, for example, identical to the pulse width of the first scan signal S4. For example, ΔV31 can be about 1V, depending on the actual situation, for example, taking that the actual display effect (e.g., grayscale brightness) is uniform as a benchmark, which is not limited in the embodiment of the present disclosure.

For example, in some examples, as shown in FIG. 10, the first phase difference is determined based on the first scan signal S3 and the first reset signal S4, that is, the first phase difference is the phase difference between the first scan signal S3 and the first reset signal S4.

For example, in some examples, as shown in FIG. 13, the voltage adjustment further includes adjusting the first level VGL_P of the first scan signal S3 to VGL_P+ΔV51 when the enable signal EN falls. For example, the width of ΔV51 is identical to the pulse width of the first signal. For example, ΔV51 can be about 0.8V-1.5V, depending on the actual situation, for example, taking that the actual display effect (e.g., grayscale brightness) is uniform as a benchmark, which is not limited in the embodiment of the present disclosure.

For example, as shown in FIG. 7, the pixel circuit further includes a second light-emitting control circuit 180 and a second reset circuit 190. The specific structure and working process of the pixel circuit can refer to the description of FIGS. 7-9, and details will not be repeated here.

For example, in the present example, the voltage adjustment further includes adjusting the second reset voltage VINIT2 based on the enable signal EN and the first signal STV.

For example, as shown in FIG. 11, the voltage adjustment includes adjusting the second reset voltage VINIT2 to VINIT2+ΔV32 at a position of a second phase difference from the falling edge of the enable signal EN when the enable signal EN falls. For example, the width of ΔV32 is identical to the pulse width of the first signal, for example, identical to the pulse width of the second scan signal S5. For example, ΔV32 can be about 1V, depending on the actual situation, for example, taking that the actual display effect (e.g., grayscale brightness) is uniform as a benchmark, which is not limited in the embodiment of the present disclosure.

For example, the second phase difference is determined based on the second scan signal S5 and the second reset signal S6, that is, the second phase difference is the phase difference between the second scan signal S5 and the second reset signal S6.

For example, as shown in FIG. 12, in some examples, the voltage adjustment further includes adjusting the first level of the data signal Vdt to Vdt+ΔV41 at a position of a third phase difference from the falling edge of the enable signal EN when the enable signal EN falls. For example, the width of ΔV41 is identical to the pulse width of the first signal. For example, ΔV41 can be about 30 mv-50 mv (millivolts), depending on the actual situation, for example, taking that the actual display effect (e.g., grayscale brightness) is uniform as a benchmark, which is not limited in the embodiment of the present disclosure.

For example, the third phase difference is determined based on the first scan signal S3 and the second scan signal S5, that is, the third phase difference is the phase difference between the first scan signal S3 and the second scan signal S5.

It should be noted that the embodiment of the present disclosure is not limited to the voltage adjustment mentioned above, but a combined adjustment can be performed on various signal voltages. For example, at least two of the first scan signal S3, the second scan signal S5, the data signal Vdt, the first reset voltage VINIT1 and the second reset voltage VINIT2 can be adjusted, so as to ensure achieving precise control of compensation amplitude (row by row or region by region) on the premise of that each compensation signal is not finely adjusted (e.g., voltage progression, special waveform, etc.), thereby reducing power consumption.

In the pixel circuit provided by the embodiment of the present disclosure, the first scan signal S3, the second scan signal S5, the data signal Vdt, the first reset voltage VINIT1 and the second reset voltage VINIT2 required for pixel driving can be adjusted during the time period when the GOA load changes, so as to eliminate the brightness difference, thereby improving the display quality.

At least one embodiment of the present disclosure further provides a display panel, the display panel includes a plurality of pixel units, and each pixel unit includes the pixel circuit provided by any embodiment of the present disclosure. The display panel can eliminate the brightness difference, thus improving the display quality.

FIG. 15 is a schematic block diagram of a display panel provided by some embodiments of the present disclosure. As shown in FIG. 15, in some embodiments, the display panel 40 includes a plurality of pixel units 410, and the plurality of pixel units 410, for example, are arranged in an array. Each pixel unit 410 includes a pixel circuit 411. The pixel circuit 411 can be the pixel circuit provided by any embodiment of the present disclosure, for example, the pixel circuit 10 described above.

For example, the display panel 40 can be an organic light-emitting diode (OLED) display panel, a quantum dot light-emitting diode (QLED) display panel or any other suitable display panel. Each pixel unit 410 includes not only the pixel unit 411, but also a light-emitting element (such as OLED, QLED, etc.).

For example, the display panel 40 can be a rectangular panel, a circular panel, an oval panel or a polygonal panel, etc. In addition, the display panel 40 can be not only a flat panel, but also a curved panel or even a spherical panel. For example, the display panel 40 can also have a touch function, that is, the display panel 40 can be a touch display panel. For example, the display panel 40 can be applied to any product or component having display function, such as a mobile phone, a tablet computer, a TV, a display, a laptop computer, a digital photo frame, a navigator, etc. For example, the display panel 40 can be a flexible display panel, so as to meet various practical application requirements; for example, the display panel 40 can be applied to a curved screen or the like.

For the sake of clarity and conciseness, the embodiments of the present disclosure do not provide all the constituent units of the display panel 40. In order to realize the basic functions of the display panel 40, those skilled in the art can provide and set other structures not shown according to specific needs, which is not limited in the embodiments of the present disclosure.

The technical effects of the display panel 40 provided in the above embodiment, can refer to the technical effects of the pixel circuit 411 provided in the embodiment of the present disclosure, which will not be repeated here.

The following should be noted:
(1) Only the structures involved in the embodiments of the present disclosure are illustrated in the drawings of the embodiments of the present disclosure, and other structures can refer to usual designs;
(2) The embodiments and features in the embodiments of the present disclosure may be combined in case of no conflict to acquire new embodiments.

What have been described above merely are exemplary embodiments of the present disclosure, and not intended to define the scope of the present disclosure, and the scope of the present disclosure is determined by the appended claims.

1. A display device, comprising a timing control circuit, a gate driving circuit and a plurality of voltage signal lines;
wherein the timing control circuit is connected with the plurality of voltage signal lines, and is configured to determine an enable signal and a first signal when load information of the gate driving circuit changes, and adjust a voltage of at least one voltage signal line among the plurality of voltage signal lines based on the enable signal and the first signal;
the gate driving circuit comprises a plurality of cascaded shift register units, which are respectively connected with the plurality of voltage signal lines and configured to output gate scan signals;
wherein a width of a voltage adjustment is determined based on a pulse width of the first signal, and a starting position of the voltage adjustment is determined based on the enable signal.

2. The display device according to claim 1, wherein the plurality of voltage signal lines comprise a first voltage signal line and a second voltage signal line configured to provide a first voltage VGH and a second voltage VGL to the plurality of shift register units;
wherein a display stage and a blanking stage are comprised within a time period of one frame, and in the display stage, the voltage adjustment comprises adjusting the first voltage VGH to VGH+ΔV111 or adjusting the second voltage VGL to VGL−ΔV211 when the enable signal falls, wherein a width of ΔV111 and a width of ΔV211 are identical to the pulse width of the first signal.

3. The display device according to claim 2, wherein in the blanking stage, the voltage adjustment includes adjusting the first voltage VGH to VGH−ΔV12 or adjusting the second voltage VGL to VGL−ΔV22 in response to a rising edge of the enable signal, wherein a width of ΔV12 and a width of ΔV22 are identical to the pulse width of the first signal.

4. The display device according to claim 2, wherein the plurality of voltage signal lines comprise a first voltage signal line and a second voltage signal line configured to provide a first voltage VGH and a second voltage VGL to the plurality of shift register units;
wherein the voltage adjustment comprises adjusting the first voltage VGH to VGH−ΔV112 and adjusting the second voltage VGL to VGL−ΔV212 when the enable signal falls, wherein a width of ΔV212 is identical to the pulse width of the first signal, a width of ΔV112 is less than the pulse width of the first signal, and amplitudes of ΔV112 and ΔV212 are smaller than amplitudes of ΔV111 and ΔV211, respectively.

5. The display device according to claim 2, wherein the first voltage is greater than the second voltage.

6. The display device according to claim 1, further comprising pixel circuits arranged in an array, wherein the plurality of voltage signal lines comprise a first scan line and a first reset line,
wherein the first scan line is connected with a data writing circuit of the pixel circuit, so as to send a first scan signal received from the first scan line to a control terminal of the data writing circuit;
the first reset line is connected with a control terminal of a first reset circuit of the pixel circuit, so as to provide a first reset signal, wherein the first reset circuit is turned on in response to the first reset signal;
the plurality of voltage signal lines further comprise a first reset voltage line connected with the first reset circuit to provide a first reset voltage;
the timing control circuit is further configured to determine a first phase difference based on the first scan signal and the first reset signal;
the voltage adjustment further comprises adjusting the first reset voltage VINIT1 to VINIT1+ΔV31 at a position of the first phase difference from a falling edge of the enable signal when the enable signal falls, wherein a width of ΔV31 is identical to the pulse width of the first signal.

7. The display device according to claim 1, further comprising pixel circuits arranged in an array, wherein the plurality of voltage signal lines comprise a first scan line,
wherein the first scan line is connected with a data writing circuit of the pixel circuit, so as to send a first scan signal S3 to a control terminal of the data writing circuit,
wherein the voltage adjustment comprises adjusting a first level VGL_P of the gate driving circuit that outputs the first scan signal to VGL_P+ΔV51 when the enable signal falls, so as to adjust the first scan signal, wherein a width of ΔV51 is identical to the pulse width of the first signal.

8. The display device according to claim 7, wherein the plurality of voltage signal lines comprise a plurality of clock signal lines configured to provide a plurality of clock signals to the gate driving circuit that outputs the first scan signal,
wherein the voltage adjustment comprises adjusting a first level V0 of the plurality of clock signals to V0−ΔV61 when the enable signal falls, so as to adjust the first scan signal, wherein a count of clock signals for voltage adjustment is determined according to the pulse width of the first signal.

9. The display device according to claim 6, wherein the plurality of voltage signal lines further comprise a second scan line and a second reset line,
wherein the second scan line is connected with a threshold compensation circuit of the pixel circuit, so as to send a second scan signal to a control terminal of the threshold compensation circuit;
the second reset line is connected with a second reset circuit of the pixel circuit to provide a second reset signal, wherein the second reset circuit is turned on in response to the second reset signal;
the plurality of voltage signal lines further comprise a second reset voltage line connected with the second reset circuit to provide a second reset voltage;
the timing control circuit is further configured to determine a second phase difference based on the second scan signal and the second reset signal;
the voltage adjustment further comprises adjusting the second reset voltage VINIT2 to VINIT2+ΔV32 at a position of the second phase difference from the falling edge of the enable signal when the enable signal falls, wherein a width of ΔV32 is identical to the pulse width of the first signal.

10. The display device according to claim 6, wherein the plurality of voltage signal lines further comprise a data line connected with the data writing circuit of the pixel circuit and configured to provide a data signal Vdt to the data writing circuit;
wherein the timing control circuit is further configured to determine a third phase difference based on the first scan signal and a second scan signal;
the voltage adjustment further comprises adjusting a first level of the data signal Vdt to Vdt+ΔV41 at a position of the third phase difference from the falling edge of the enable signal when the enable signal falls, wherein a width of ΔV41 is identical to the pulse width of the first signal.

11. The display device according to claim 1, wherein the plurality of voltage signal lines further comprise a trigger signal line configured to provide a trigger signal to the gate driving circuit;
wherein the first signal is a trigger signal.

12. A pixel circuit, comprising: a driving circuit, a data writing circuit, a threshold compensation circuit, a storage circuit, a first light-emitting control circuit and a first reset circuit;
the driving circuit comprises a control terminal, a first terminal and a second terminal, and is configured to control a driving current flowing through a light-emitting element;
the data writing circuit is connected with the first terminal of the driving circuit, and is configured to write a data signal to the first terminal of the driving circuit in response to a first scan signal;
the threshold compensation circuit is connected between the control terminal of the driving circuit and the second terminal of the driving circuit, and is configured to write a compensation signal based on the data signal to the control terminal of the driving circuit in response to a second scan signal;
the storage circuit is connected with the control terminal of the driving circuit and a first voltage line, and is configured to store the compensation signal and hold the compensation signal at the control terminal of the driving circuit;
the first light-emitting control circuit is connected with the first voltage line and the first terminal of the driving circuit, and is configured to apply a first voltage provided by the first voltage line to the first terminal of the driving circuit in response to a first light-emitting control signal;
the first reset circuit is connected with the threshold compensation circuit, and is configured to apply a first reset voltage to the control terminal of the driving circuit in response to a first reset signal;
the control terminal of the driving circuit and the storage circuit are connected at a first node, and the first light-emitting control circuit and the first terminal of the driving circuit are connected at a second node;
wherein a voltage of the first scan signal, the second scan signal, the data signal or the first reset voltage is configured to be adjusted based on an enable signal and a first signal determined when load information of a gate driving circuit changes, wherein a width of the voltage adjustment is determined based on a pulse width of the first signal, and a starting position of the voltage adjustment is determined based on the enable signal.

13. The pixel circuit of claim 12, wherein the voltage adjustment comprises adjusting the first reset voltage VINIT1 to VINIT1+ΔV31 at a position of a first phase difference from a falling edge of the enable signal when the enable signal falls, wherein a width of ΔV31 is identical to the pulse width of the first signal.

14. The pixel circuit according to claim 13, wherein the first phase difference is determined based on the first scan signal and the first reset signal.

15. The pixel circuit according to claim 12, wherein the voltage adjustment comprises adjusting a first level VGL_P of the gate driving circuit that outputs the first scan signal to VGL_P+ΔV51 or adjusting a first level V0 of a plurality of clock signals of the gate driving circuit that outputs the first scan signal to V0−ΔV61 when the enable signal falls, so as to adjust the first scan signal, wherein a width of ΔV51 is identical to the pulse width of the first signal.

16. The pixel circuit according to claim 12, wherein the pixel circuit further comprises a second light-emitting control circuit and a second reset circuit;
the second light-emitting control circuit is connected with the second terminal of the driving circuit and the light-emitting element, and is configured to apply a voltage of the second terminal of the driving circuit to the light-emitting element in response to a second light-emitting control signal;
the second reset circuit is connected with the second light-emitting control circuit and the light-emitting element, and is configured to apply a second reset voltage to the light-emitting element in response to a second reset signal;
the second light-emitting control circuit and the second terminal of the driving circuit are connected at a third node, and the second reset circuit, the second light-emitting control circuit and the light-emitting element are connected at a fourth node;
wherein the voltage adjustment further comprises adjusting the second reset voltage based on the enable signal and the first signal.

17. The pixel circuit according to claim 16, wherein the voltage adjustment comprises adjusting the second reset voltage VINIT2 to VINIT2+ΔV32 at a position of a second phase difference from the falling edge of the enable signal when the enable signal falls, wherein a width of ΔV32 is identical to the pulse width of the first signal.

18. The pixel circuit according to claim 17, wherein the second phase difference is determined based on the second scan signal and the second reset signal.

19. The pixel circuit according to claim 12, wherein the voltage adjustment further comprises adjusting a first level of the data signal Vdt to Vdt+ΔV41 at a position of a third phase difference from the falling edge of the enable signal when the enable signal falls, wherein a width of ΔV41 is identical to the pulse width of the first signal;
wherein the third phase difference is determined based on the first scan signal and the second scan signal.

20. (canceled)

21. A display panel, comprising a plurality of pixel units, wherein each of the plurality of pixel units comprises the pixel circuit according to claim 12.
